(19) United States
(12) Patent Application Publication
(10) Pub. No.: US 2023/0215022 A1
(43) Pub. Date: Jul. 6, 2023

(54) IMAGE-BASED MOTION DETECTION METHOD

(71) Applicants: Shanghai Shende Green Medical Era Healthcare Technology Co., Ltd., Shanghai (CN); Shende (Ningbo) Medical Device Technology Co., Ltd, Ningbo (CN); Nantong Shende Medical Device Technology Co., Ltd, Nantong (CN)

(72) Inventors: Bo WEI, Shanghai (CN); Junjie GUO, Shanghai (CN); Shengfa ZHANG, Shanghai (CN); Jiawei GU, Shanghai (CN); Zhiqiang SU, Shanghai (CN); Bo YANG, Shanghai (CN); Hao WU, Shanghai (CN); Lei CUI, Shanghai (CN); Zhou TIAN, Shanghai (CN)

(73) Assignees: Shanghai Shende Green Medical Era Healthcare Technology Co., Ltd., Shanghai (CN); Shende (Ningbo) Medical Device Technology Co., Ltd, Ningbo (CN); Nantong Shende Medical Device Technology Co., Ltd, Nantong (CN)

(21) Appl. No.: 18/175,819

(22) Filed: Feb. 28, 2023

Related U.S. Application Data
(63) Continuation of application No. PCT/CN2021/082588, filed on Mar. 24, 2021.

(30) Foreign Application Priority Data
Aug. 31, 2020 (CN) 202010894625.2

(51) Int. Cl. G06T 7/246; G06T 7/11; G06V 10/44; G06V 10/74; G06V 10/762; G06V 10/764

(52) U.S. Cl. CPC G06T 7/246; G06T 7/11; G06V 10/44; G06V 10/761; G06V 10/762; G06V 10/764; G06V 2201/07

(57) ABSTRACT

Disclosed is an image-based motion detection method. The method specifically includes: acquiring a reference image of a detecting object, determining several first detecting points in the reference image, extracting basic markings centered on the first detecting points in the reference image and classifying all the basic markings into several categories; acquiring a detecting image of the detecting object; matching the basic markings in the detecting image, obtaining an offset vector of each basic marking, and determining whether the basic marking has moved according to a norm of the offset vector of the basic marking; determining whether the number of the basic markings that have moved in each category is greater than a third threshold, if yes, determining that the category has moved; and if no, determining that the category has not moved; and determining a moving state of the detecting object according to a moving state of each category.

### CROSS-REFERENCE TO RELATED APPLICATIONS

This application is a continuation application of International Application No. PCT/CN2021/082588, filed on Mar. 24, 2021, which claims priority to Chinese Patent Application No. 202010894625.2, filed on Aug. 31, 2020. The disclosures of the above-mentioned applications are incorporated herein by reference in their entireties.

### TECHNICAL FIELD

The present disclosure relates to the technical field of motion detection method, and in particular, to an image-based motion detection method.

### BACKGROUND

On the one hand, for some non-invasive treatments, anatomical surface images of the treatment site need to be acquired in real time to observe and monitor the treatment during the treatment process, and nuclear magnetic resonance imaging (NMRI) and computed tomography (CT) are generally applied. On the other hand, the non-invasive treatment equipment may not be fixed to the body, which may cause treatment accidents if the patient moves. For this situation, intraoperative monitoring images can be used to detect the patient's motion.

Existing methods of motion detection may be divided into image-based detection and sensor-based detection.

Sensor-based detection methods in non-invasive treatment, such as using laser rangefinders or ultrasound radar to detect movement, not only require an additional equipment, but also may only detect extracorporeal information except internal body movements caused by breathing or some reasons.

Most of the image-based motion detection methods adopt the processing of images generated by cameras and other devices and the processing includes inter-frame differencing, background differencing and optical flowing. Real-world images generated by cameras generally contain color information. The image content includes background and target. In some cases, the target object is known and the features of the target can be obtained from images from other sources, thereby to track the target on the detection image. In other cases, a deep image and a sensor may provide more information. As for non-invasive treatments, anatomical surface images generated by medical imaging equipment should be used, since the target of the detection movement is the tissue and organs inside the body. Medical images, relative to images of real objects, have only pure grayscale information and relatively less image details. Since the medical images are anatomical surface images, tissues and organs may be mixed and stacked in different forms caused by different imaging angles and different imaging methods. Such that it is also difficult to obtain target features from images of other sources. Therefore, the existing motion detection algorithms are not applicable to medical images.

In the motion detection based on medical images, the current practice determines the movement only by simply comparing the images before and during treatment or the marked points in the images. However, the human body is not a rigid body, the movement that occurs may be partial, and the moving parts may not affect the treatment. Because the imaging parameters or the surrounding environment change, the images of the unmoving parts at different times may also have different grayscale or noise, which brings additional interference to the detection. Therefore, current motion detection means lack flexible adaptations for motion judgment.

### SUMMARY

The purpose of the present disclosure is to provide an image-based motion detection method with good accuracy, flexibility and comprehensive information in order to overcome the above-mentioned defects of the prior art.

The purpose of the present disclosure may be achieved by the following technical solutions.

The present disclosure provides an image-based motion detection method, including:

acquiring a reference image of a detecting object, determining several first detecting points in the reference image, extracting basic markings centered on the first detecting points in the reference image and classifying all the basic markings into several categories, wherein each category comprises at least one basic marking;

acquiring a detecting image of the detecting object, wherein the detecting image and the reference image include the same image parameters and the image parameters include position, direction, size and resolution;

matching the basic markings in the detecting image with the basic markings in the reference image, obtaining an offset vector of each basic marking between the reference image and the detecting image, and determining whether a norm of the offset vector of each basic marking is greater than a second threshold, if yes, determining that the basic marking has moved; and if no, determining that the basic marking has not moved;

determining whether the number of the basic markings that have moved in each category is greater than a third threshold, if yes, determining that the category has moved; and if no, determining that the category has not moved. Both the second threshold and the third threshold can be set flexibly, increasing the threshold reduces false positives and decreasing the threshold low reduces false negatives, which can be set flexibly for different application scenarios.

determining a whole moving state and a part moving state of the detecting object according to a moving state of each category. The moving states include whole motion, part motion, and no motion.

In some embodiments, the method further includes clustering all basic markings of each category to obtain several clusters; recording one cluster including the largest number of the basic markings as Cmax; in response that the proportion of the number of basic markings in Cmax to the number of basic markings in the category of Cmax is not less than a first threshold, calculating an average value X̅ of offset vector of all the basic markings in Cmax and determining X̅ as the offset vector of basic markings in the other clusters of the category of Cmax, which may help to correct the basic marking with large deviation.

In some embodiments, the operation of clustering all basic markings of each category specifically includes classifying two basic markings into a cluster if a norm of a difference between offset vectors of the two basic markings is less than a fifth threshold; and classifying unclassified basic markings into the cluster if differences between offset vectors of the unclassified basic markings and an average value of offset vectors in the cluster.

In some embodiments, the basic markings are image fragments, the operation of extracting image fragments specifically includes extracting images within a range of a first preset distance centered on the first detecting points to construct the image fragments.

In some embodiments, in response that the number of the first detecting points in the reference image is less than a fourth threshold, expanding detecting points, and the operation of expanding the detecting points includes:

determining the fourth threshold; centered on the first detecting points, determining several second detecting points within a range of a second preset distance; centered on the second detecting points, extracting images in the range of the first preset distance in the reference image to construct the expanded image fragments. The first preset distance may be set flexibly.

In some embodiments, the method further includes determining an entropy threshold; and saving images whose entropy is greater than the entropy threshold as expanded image fragments.

In some embodiments, the basic markings are image feature points, the operation of extracting the image feature points specifically includes:

centered on the first detecting points, identifying the image feature points within a range of a third preset distance in the reference image.

In some embodiments, the image feature points are Harris corner points.

In some embodiments, a density-based clustering algorithm is adopted to classify satisfied basic markings into a category.

In some embodiments, the clustering algorithm is density-based spatial clustering of applications with noise (DB SCAN).

In some embodiments, the method further includes dividing the reference image to obtain different image dividing units and classifying the basic markings in a same image dividing unit into a same category.

Compared with the prior art, the present disclosure has the following beneficial effects.

(1) In the present disclosure, the method includes acquiring a reference image of a detecting object, determining several first detecting points in the reference image, extracting basic markings centered on the first detecting points in the reference image and classifying all the basic markings into several categories, wherein each category comprises at least one basic marking; acquiring a detecting image of the detecting object, wherein the detecting image and the reference image include the same image parameters and the image parameters include position, direction, size and resolution; matching the basic markings in the detecting image with the basic markings in the reference image, obtaining an offset vector of each basic marking between the reference image and the detecting image, and determining whether a norm of the offset vector of each basic marking is greater than a second threshold, if yes, determining that the basic marking has moved; and if no, determining that the basic marking has not moved; determining whether the number of the basic markings that have moved in each category is greater than a third threshold, if yes, determining that the category has moved; and if no, determining that the category has not moved; and determining a whole moving state and a part moving state of the detecting object according to a moving state of each category. The method may avoid the interference of the basic marking with large deviation on the detection results. The detection results are more comprehensive and accurate. The number and position of the first detection point, the second threshold and the third threshold can be set flexibly, thereby balancing the accuracy and efficiency of motion detection and having good flexibility.

(2) The method further includes clustering all basic markings of each category to obtain several clusters; recording one cluster including the largest number of the basic markings as Cmax; in response that the proportion of the number of basic markings in Cmax to the number of basic markings in the category of Cmax is not less than a first threshold, calculating an average value X̅ of offset vector of all the basic markings in Cmax and determining X̅ as the offset vector of basic markings in the other clusters of the category of Cmax, which may help to correct the basic marking with large deviation and improve the accuracy of detection.

(3) The present disclosure adopts the image fragments as basic markings by extracting images within a range of a first preset distance centered on the first detecting points to construct the image fragments, which achieves higher matching accuracy of the basic marking and more accurate motion detection results of the basic marking.

(4) The present disclosure adopts the operations of determining a fourth threshold; in response that the number of the first detecting points in the reference image is less than a fourth threshold, expanding detecting points; centered on the first detecting points, determining several second detecting points within a range of a second preset distance; determining an entropy threshold; centered on the second detecting points, extracting images in the range of the first preset distance in the reference image; and saving images whose entropy is greater than the entropy threshold as expanded image fragments, which ensures adequate number of image fragments and the validity of each image fragment with high detection accuracy.

(5) The present disclosure adopts the operations of dividing the reference image to obtain different image dividing units and classifying the basic markings in a same image dividing unit into a same category. It is suitable for anatomical structures of different sizes and can also perform part motion detection of anatomical structures.

### BRIEF DESCRIPTION OF THE DRAWINGS

FIG. 1 is a schematic flowchart of an image-based motion detection method according to some embodiments of the present disclosure.

FIG. 2 is a schematic view of classifying categories according to some embodiments of the present disclosure.

FIG. 3 is a schematic view of clustering according to some embodiments of the present disclosure.

FIG. 4 is a schematic view of correcting categories according to some embodiments of the present disclosure.

### DETAILED DESCRIPTION OF THE EMBODIMENTS

The present disclosure is described in detail below in conjunction with the drawings and specific embodiments. The embodiments are implemented with the technical solution of the present disclosure, which gives detailed implementation and specific operation procedures. But the protection scope of the present disclosure is not limited to the following embodiments.

### Embodiment 1

The present disclosure provides an image-based motion detection method, including:

Acquiring a reference image of a detecting object, determining several first detecting points in the reference image, extracting basic markings centered on the first detecting points in the reference image and classifying all the basic markings into several categories, wherein each category comprises at least one basic marking;

Acquiring a detecting image of the detecting object, wherein the detecting image and the reference image include the same image parameters and the image parameters include position, direction, size and resolution;

Matching the basic markings in the detecting image with the basic markings in the reference image, obtaining an offset vector of each basic marking between the reference image and the detecting image, and determining whether a norm of the offset vector of each basic marking is greater than a second threshold, if yes, determining that the basic marking has moved; and if no, determining that the basic marking has not moved;

Determining whether the number of the basic markings that have moved in each category is greater than a third threshold, if yes, determining that the category has moved; and if no, determining that the category has not moved;

Determining a whole moving state and a part moving state of the detecting object according to a moving state of each category.

### Embodiment 2

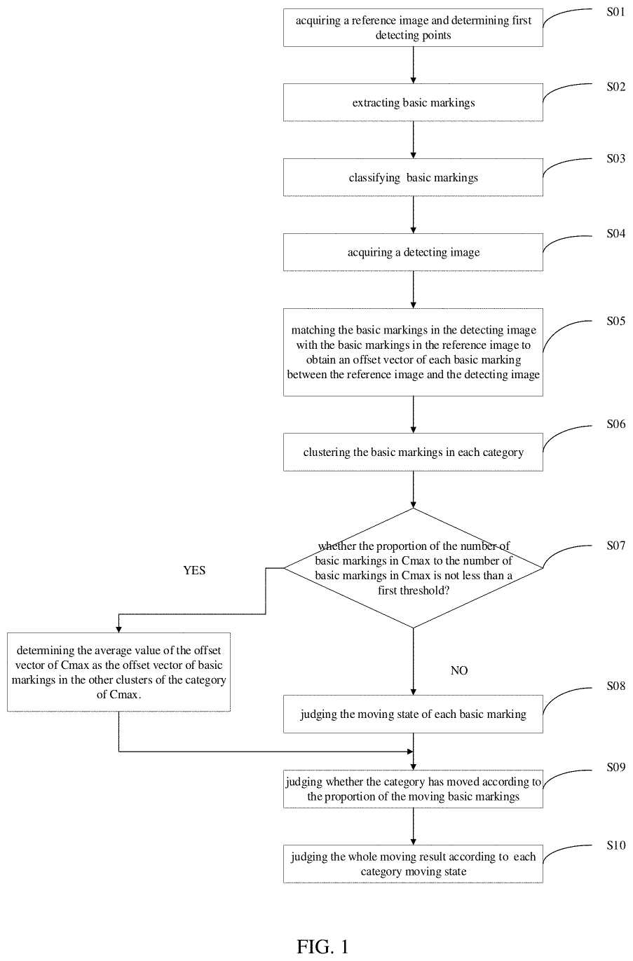

The present disclosure provides an image-based motion detection method as shown in FIG. 1, including:

S01: acquiring a reference image of a detecting object and determining several first detecting points in parts of the reference image to determine whether movement occurs;

S02: extracting basic markings centered on the first detecting points in the reference image, wherein the basic markings are image fragments, extracting images within a range of a first preset distance centered on the first detecting points to construct the image fragments;

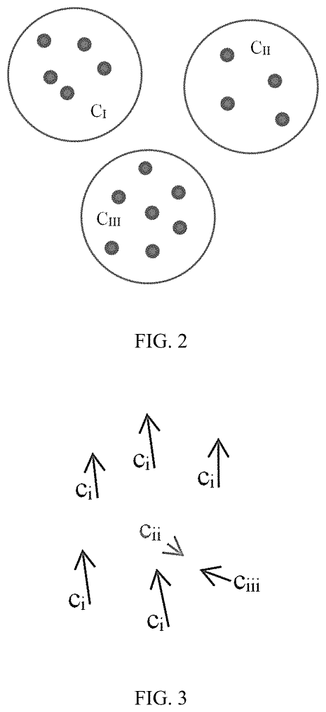

S03: as shown in FIG. 2, classifying satisfied basic markings into a category by adopting a density-based clustering algorithm to obtain three categories denoted as CI, CII and CIII, and each category includes at least one basic marking, wherein the clustering algorithm is DB SCAN. The offset vectors of the basic markings located in the same category have approximate offset vectors if motion occurs;

S04: acquiring a detecting image of the detecting object, wherein the detecting image and the reference image include the same image parameters and the image parameters include position, direction, size and resolution;

S05: matching and comparing the position of the basic markings in the detecting image with the basic markings in the reference image to obtain an offset vector of each basic marking between the reference image and the detecting image;

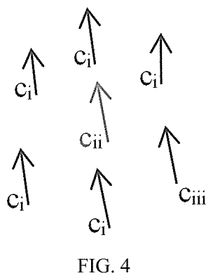

S06: clustering all basic markings of each category to obtain several clusters; classifying two basic markings into a cluster if a norm of a difference between offset vectors of the two basic markings is less than a fifth threshold; and classifying unclassified basic markings into the cluster if differences between offset vectors of the unclassified basic markings and an average value of offset vectors in the cluster to obtain several clusters, and recording one cluster including the largest number of the basic markings as Cmax, as shown in FIG. 3, ci, cii and ciii are three different clusters in the same category, wherein ci includes the largest number of the basic markings and is recorded as Cmax;

S07: in response that the proportion of the number of basic markings in Cmax to the number of basic markings in the category of Cmax is not less than a first threshold, calculating an average value X̅ of offset vector of all the basic markings in Cmax; and determining X̅ as the offset vector of basic markings in the other clusters of the category of Cmax. As shown in FIG. 4, determining the average value of offset vector of all the basic markings in ci as the offset vector of basic markings in cii and ciii;

S08: determining whether a norm of the offset vector of each basic marking is greater than a second threshold, if yes, determining that the basic marking has moved; and if no, determining that the basic marking has not moved;

S09: determining whether the proportion of the number of the basic markings that have moved in each category is greater than a third threshold, if yes, determining that the category has moved; and if no, determining that the category has not moved;

S10: determining a whole moving state and a part moving state of the detecting object according to a moving state of each category. The moving states include whole motion, part motion, and no motion.

The operation of determining the fourth threshold; in response that the number of the first detecting points in the reference image is less than a fourth threshold, expanding detecting points, and the operation of expanding the detecting points includes:

centered on the first detecting points, determining several second detecting points within a range of a second preset distance; centered on the second detecting points, extracting images in the range of the first preset distance in the reference image to construct the image fragments; determining an entropy threshold; and saving images whose entropy is greater than the entropy threshold as expanded image fragments. The entropy value reflects the amount of information contained in the image segment, which can reflect whether the image segment contains anatomical structures or not. Such that all the image segments obtained by the expansion contain anatomical structures.

In the motion detection method, the second detecting point is used to make up for the insufficient number of the first detecting point, thereby to expand the detecting range. The second detecting point and the first detecting point are in the same anatomical structure, which may avoid the movement of other parts form disturbing the detection results. The first detection point can be set at a location with good anatomical structures, thereby facilitating the matching of individual image segments in the detecting image.

### Embodiment 3

In some embodiments, the basic markings are image feature points and the image feature points are Harris corner points. The operation of extracting the image feature points specifically includes centered on the first detecting points, identifying the image feature points within a range of a third preset distance in the reference image. Other operations are similar to embodiment 2.

### Embodiment 4

In some embodiments, the method further includes dividing the reference image based on different anatomical structures to obtain different image dividing units and classifying the basic markings in the same image dividing unit into the same category. Other operations are similar to embodiment 2.

The image-based motion detection methods provided in embodiments 1-4 adopt the way of clustering to process the results of all basic markings, which may correct the basic markings with large deviations. Meanwhile the part motion of the detecting object may be observed according to the motion of the category, and the motion state may be judged by judging the proportion of all basic marking, which may avoid the interference of some wrong basic markings. Since the threshold value may be changed, the method may be flexibly used in different usage scenarios.

The above describes in detail a preferred specific embodiment of the present disclosure. It should be understood that a person of ordinary skill in the art can make many modifications and changes according to the idea of the present disclosure without creative working. Therefore, any technical solution that can be obtained by logical analysis, reasoning or limited experiments based on the prior art by a person skilled in the art in accordance with the idea of the present disclosure shall fall within the protection scope determined by the claims.

What is claimed is:

1. An image-based motion detection method, comprising:
acquiring a reference image of a detecting object, determining several first detecting points in the reference image, extracting basic markings centered on the first detecting points in the reference image and classifying all the basic markings into several categories, wherein each category comprises at least one basic marking;
acquiring a detecting image of the detecting object, wherein the detecting image and the reference image comprise the same image parameters and the image parameters comprise position, direction, size and resolution;
matching the basic markings in the detecting image with the basic markings in the reference image, obtaining an offset vector of each basic marking between the reference image and the detecting image, and determining whether a norm of the offset vector of each basic marking is greater than a second threshold, if yes, determining that the basic marking has moved; and if no, determining that the basic marking has not moved;
determining whether the number of the basic markings that have moved in each category is greater than a third threshold, if yes, determining that the category has moved; and if no, determining that the category has not moved; and
determining a whole moving state and a part moving state of the detecting object according to a moving state of each category.

2. The image-based motion detection method of claim 1, further comprising:
clustering all basic markings of each category to obtain several clusters;
recording one cluster comprising the largest number of the basic markings as Cmax;
in response that the proportion of the number of basic markings in Cmax to the number of basic markings in the category of Cmax is not less than a first threshold, calculating an average value X̅ of offset vector of all the basic markings in Cmax; and
determining X̅ as the offset vector of basic markings in the other clusters of the category of Cmax.

3. The image-based motion detection method of claim 2, wherein the operation of clustering all basic markings of each category specifically comprises:
classifying two basic markings into a cluster if a norm of a difference between offset vectors of the two basic markings is less than a fifth threshold; and
classifying unclassified basic markings into the cluster if differences between offset vectors of the unclassified basic markings and an average value of offset vectors in the cluster.

4. The image-based motion detection method of claim 1, wherein the basic markings are image fragments, the operation of extracting image fragments specifically comprises:
extracting images within a range of a first preset distance centered on the first detecting points to construct the image fragments.

5. The image-based motion detection method of claim 4, wherein in response that the number of the first detecting points in the reference image is less than a fourth threshold, expanding detecting points, and the operation of expanding the detecting points comprises:
determining the fourth threshold;
centered on the first detecting points, determining several second detecting points within a range of a second preset distance;
determining an entropy threshold;
centered on the second detecting points, extracting images in the range of the first preset distance in the reference image;
saving images whose entropy is greater than the entropy threshold as expanded image fragments.

6. The image-based motion detection method of claim 1, wherein the basic markings are image feature points, and the operation of extracting the image feature points specifically comprises:
centered on the first detecting points, identifying the image feature points within a range of a third preset distance in the reference image.

7. The image-based motion detection method of claim 6, wherein the image feature points are Harris corner points.

8. The image-based motion detection method of claim 1, wherein a density-based clustering algorithm is adopted to classify satisfied basic markings into a category.

9. The image-based motion detection method of claim 8, wherein the clustering algorithm is density-based spatial clustering of applications with noise (DBSCAN).

10. The image-based motion detection method of claim 1, further comprising:
dividing the reference image to obtain different image dividing units and classifying the basic markings in a same image dividing unit into a same category.
